(19) United States
(12) Patent Application Publication
(10) Pub. No.: US 2026/0268381 A1
(43) Pub. Date: Sep. 10, 2026

(54) ALCOHOLIC BEVERAGE TOKEN TRANSACTION SUPPORT APPARATUS, ALCOHOLIC BEVERAGE TOKEN TRANSACTION SUPPORT METHOD, PROGRAM, AND RECORDING MEDIUM

(71) Applicant: LEAF PUBLICATIONS CO., LTD., Kyoto-shi, Kyoto (JP)

(72) Inventor: Hiroyoshi HAZAMA, Kyoto (JP)

(21) Appl. No.: 18/993,369

(22) PCT Filed: Sep. 4, 2023
(86) PCT No.: PCT/JP2023/032270

§ 371 Date: Jan. 10, 2025

(30) Foreign Application Priority Data
Feb. 24, 2023 (JP) 2023-027455

(51) Int. Cl. G06Q 30/0601; G06Q 10/083

(52) U.S. Cl. CPC G06Q 30/0607; G06Q 10/083

(57) ABSTRACT

An alcoholic beverage token transaction support apparatus that includes: a token issuance request acquisition part; a token issuance part; a marketing part; a transaction information acquisition part; and a token management part. The token issuance request acquisition part acquires token issuance request information, the token issuance request information includes product identification information of an alcoholic beverage product that is a transaction target, the token issuance part issues alcoholic beverage token information on a blockchain based on the token issuance request information for the alcoholic beverage product specified by the product identification information, the marketing part releases the alcoholic beverage token information on a market, the transaction information acquisition part acquires transaction information of the alcoholic beverage token information in the market, and the token management part updates owner information of the alcoholic beverage token information on the blockchain based on the transaction information.

### TECHNICAL FIELD

The present disclosure relates to an alcoholic beverage token transaction support apparatus, an alcoholic beverage token transaction support method, a program, and a recording medium.

### BACKGROUND ART

In recent years, a variety of products are traded online with the development of EC (electronic commerce) sites and the like. For example, the following Patent Literature 1 describes a program that allows selling of alcoholic beverage products such as sake and the like on EC sites.

### CITATION LIST

### Patent Literature

Patent Literature 1: JP 2021-131743A

### SUMMARY OF INVENTION

### Technical Problem

In fact, authenticity and value of products on EC sites are not secured. Thus, when purchasing such products, purchasers might receive products different from the ones they ordered. Trading of alcoholic beverages is especially becoming a problem because there are some cases that the alcoholic beverages are replaced by a different liquor and only the containers are authentic.

### Solution to Problem

Hence, it is an object of the present disclosure to provide an alcoholic beverage token transaction support apparatus, an alcoholic beverage token transaction support method, and a program, which can secure the value of alcoholic beverages and enhance their market value.

To achieve the above object, the present disclosure provides an alcoholic beverage token transaction support apparatus, including: a token issuance request acquisition part; a token issuance part; a marketing part; a transaction information acquisition part; and a token management part, wherein the token issuance request acquisition part acquires token issuance request information, the token issuance request information includes product identification information of an alcoholic beverage product that is a transaction target, the token issuance part issues alcoholic beverage token information on a blockchain based on the token issuance request information, for the alcoholic beverage product specified by the product identification information, the marketing part releases the alcoholic beverage token information on a market, the transaction information acquisition part acquires transaction information of the alcoholic beverage token information in the market, and the token management part updates owner information of the alcoholic beverage token information on the blockchain based on the transaction information.

The present disclosure also provides an alcoholic beverage token transaction support method, including: acquiring a token issuance request; issuing a token; marketing the token; acquiring transaction information; and managing the token, wherein token issuance request information is acquired in the acquiring the token issuance request, the token issuance request information includes product identification information of an alcoholic beverage product that is a transaction target, alcoholic beverage token information is issued on a blockchain based on the token issuance request information, for the alcoholic beverage product specified by the product identification information in the issuing the token, the alcoholic beverage token information is released on a market in the marketing the token, the transaction information of the alcoholic beverage token information in the market is acquired in the acquiring the transaction information, and owner information of the alcoholic beverage token information on the blockchain is updated based on the transaction information in the managing the token.

The present disclosure also provides a program for causing a computer to execute the following processes, including: a token issuance request acquisition process; a token issuance process; a marketing process; a transaction information acquisition process; and a token management process, wherein token issuance request information is acquired by the token issuance request acquisition process, the token issuance request information includes product identification information of an alcoholic beverage product that is a transaction target, alcoholic beverage token information is issued on a blockchain based on the token issuance request information, for the alcoholic beverage product specified by the product identification information by the token issuance process, the alcoholic beverage token information is released on a market by the marketing process, transaction information of the alcoholic beverage token information in the market is acquired by the transaction information acquisition process, and owner information of the alcoholic beverage token information on the blockchain is updated based on the transaction information by the token management process.

The present disclosure also provides a computer-readable recording medium recorded with a program for causing a computer to execute the following processes, including: a token issuance request acquisition process; a token issuance process; a marketing process; and a transaction information acquisition process; wherein a token issuance request information is acquired by the token issuance request acquisition process, the token issuance request information includes a product identification information of an alcoholic beverage product that is a transaction target, an alcoholic beverage token information is issued on a blockchain based on the token issuance request information, for the alcoholic beverage product specified by the product identification information by the token issuance process, the alcoholic beverage token information is released on a market by the marketing process, a transaction information of the alcoholic beverage token information in the market is acquired by the transaction information acquisition process, and an owner information of the alcoholic beverage token information on the blockchain is updated based on the transaction information by the token management process.

### Advantageous Effects of Invention

The present disclosure can secure the value of alcoholic beverages and enhance their market value.

### BRIEF DESCRIPTION OF DRAWINGS

FIG. 1 is a block diagram showing an example configuration of the apparatus of the present disclosure.

FIG. 2 is a block diagram showing an example of a hardware configuration of the apparatus of the present disclosure.

FIG. 3 is a flowchart of a processing example in the apparatus of the present disclosure.

FIG. 4 is a block diagram showing an example configuration of the apparatus of the present disclosure.

FIG. 5 is a schematic view showing an example display of a terminal in the use of the apparatus of the present disclosure.

FIG. 6 is a schematic view showing an example display of a terminal in the use of the apparatus of the present disclosure.

### DESCRIPTION OF EMBODIMENTS

In the present disclosure, an “alcoholic beverage”, for example, is not particularly limited as long as being a beverage containing alcohol. The alcoholic beverage may be, for example, any of brewage, distilled liquor, and mixed liquor. The alcoholic beverage in the present disclosure is preferred to be, for example, sake, beer, plum liquor, shochu, or the like, and particularly preferred to be sake.

The example embodiments of the present disclosure are described below with reference to the drawings. It is to be noted, however, that the present disclosure is by no means limited or restricted by the following example embodiments. In the following drawings, identical parts are indicated with identical reference signs. Regarding the descriptions of the example embodiments, reference can be made to one another unless otherwise stated. Furthermore, the configurations of the example embodiments can be combined unless otherwise stated.

### First Embodiment

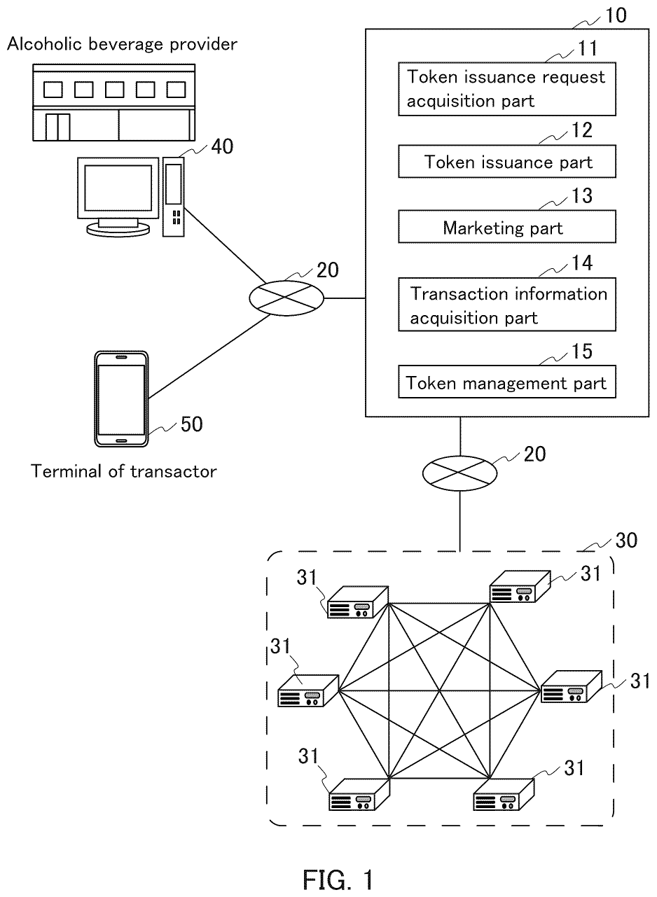

FIG. 1 is a block diagram showing an example configuration of an alcoholic beverage token transaction support apparatus 10 of the present disclosure. As shown in FIG. 1, the apparatus 10 includes a token issuance request acquisition part 11, a token issuance part 12, a marketing part 13, a transaction information acquisition part 14, and a token management part 15. The apparatus 10 may include an input part, an output part, a display part, and/or a storage part that are not shown. As shown in FIG. 1, for example, the apparatus 10 is capable of communicating with a blockchain network 30 via a communication line network 20, and further with a terminal of an alcoholic beverage provider 40 and a terminal of an alcoholic beverage token information transactor 50.

The apparatus 10 may be, for example, one apparatus including said parts, or may be an apparatus connectable to each of the parts via a communication line network. The apparatus 10 is also connectable to an external unit described below via the communication line network. The communication line network is not particularly limited and may be a known network, which may be, for example, wired or wireless. Examples of the communication line network include an internet line, WWW (World Wide Web), a telephone line, LAN (Local Area Network), SAN (Storage Area Network), DTN (Delay Tolerant Networking), LPWA (Low Power Wide Area), and L5G (local 5G). Examples of wireless communication include WI-FI® (registered trademark), BLUETOOTH® (registered trademark), local 5G, and LPWA. The wireless communication may be a form where apparatuses directly communicate with each other (Ad-Hoc communication), infrastructure communication, indirect communication via an access point, or the like. The apparatus 10 may be built in a server as a system, for example. The apparatus 10 may also be, for example, a personal computer (PC, e.g., a desktop PC and a laptop), a smartphone, a tablet terminal, or the like with the program of the present disclosure installed therein. The apparatus 10 may be, for example, a form of cloud computing, edge computing, or the like such that at least one of the parts is on a server and the rest of the parts are on a terminal.

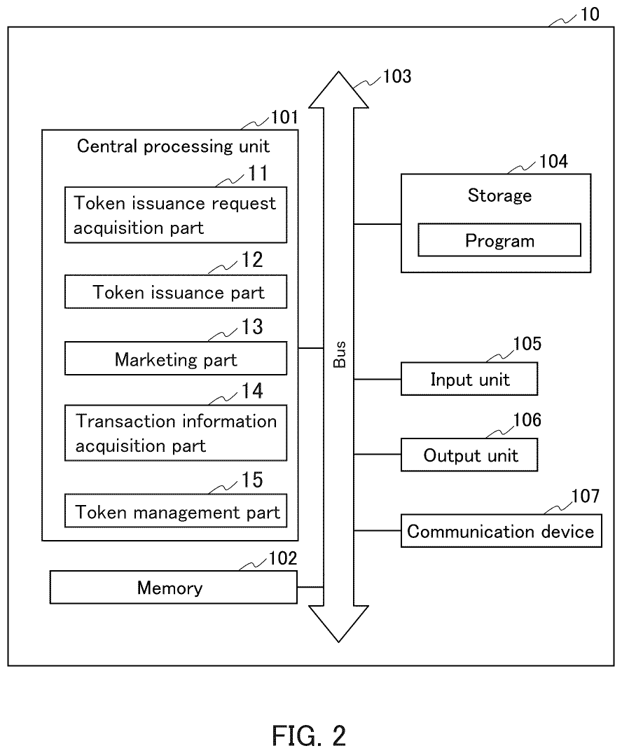

FIG. 2 is a block diagram exemplifying a hardware configuration of the apparatus 10. The apparatus 10 includes, for example, a central processing unit (CPU, GPU, or the like) 101, a memory 102, a bus 103, a storage 104, an input unit 105, an output unit 106, a communication device 107, and the like. These units in the apparatus 10 are connected to each other through their respective interfaces (I/F) via the bus 103.

The central processing unit 101 cooperatively operates with other configurations and controls the overall operation of the apparatus 10 with a controller (such as a system controller, and an I/O controller) or the like. In the apparatus 10, the central processing unit 101 executes the program of the present disclosure or other programs, and reads and writes various information, for example. Specifically, for example, the central processing unit 101 functions as the token issuance request acquisition part 11, the token issuance part 12, the output part 14, the transaction information acquisition part 14, and the token management part 15. The apparatus 10 may be provided with other arithmetic operation units such as CPU, GPU (Graphics Processing Unit), APU (Accelerated Processing Unit), and the like or a combination thereof.

The bus 103 is, for example, connectable to an external unit. Examples of the external unit include an external storage (external data base or the like), a printer, an external input unit, an external display, and an external imaging unit. The apparatus 10 is, for example, connectable to an external network (the communication line network) with the communication device 107 connected to the bus 103, and is connectable to other units via the external network.

A memory 102 may be, for example, a main memory (main storage). When the central processing unit 101 performs the processing, for example, the memory 102 reads the program of the present disclosure or other various operation programs stored in the storage 104 described below, the central processing unit 101 receives data from the memory 102 and executes the program. The main memory may be RAM (Random Access Memory), for example. The memory 102 may be ROM (Read Only Memory), for example.

The storage 104 is referred to as a so-called auxiliary storage to the main memory (main storage), for example. As described above, operation programs including the program of the present disclosure are stored in the storage 104. The storage 104 may be a combination of a recording medium and a drive for performing reading and writing to the recording medium, for example. The recording medium is not particularly limited and may be a built-in type or an external type, and examples thereof include HD (Hard Disk), CD-ROM, CD-R, CD-RW, MO, DVD, a flash memory, and a memory card. The storage 104 may be a hard disk drive (HDD) or a solid state drive (SSD) in which a drive and a storage medium are integrated with each other, for example. When the apparatus 10 includes the storage part, for example, the storage 104 functions as the storage part. The storage part can store, for example, information on the alcoholic beverage provider and the transactor (identification information (e.g., a name or a handle name, address, a phone number, and ID), attribute information (e.g., sex, age, a belonging organization, address, contact information, hobbies, and preferences), biological information, or the like), token issuance request information, product identification information, alcoholic beverage token information, transaction information, owner information, optional information, product management instruction information, management information, shipping request information, shipping instructions, and the like.

In the apparatus 10, the memory 102 and the storage 104 can also store various information such as log information, information acquired from external data bases (not shown) or external units, information generated by the apparatus 10, and information used for executing the processing by the apparatus 10. In this case, the memory 102 and the storage 104 may store the above-described information on the user of the apparatus, or the like, for example. Note that, at least several pieces of the information may be stored in an external server other than the memory 102 or the storage 104, or may be dispersedly stored in several terminals with the blockchain technology or the like, for example.

The apparatus 10 is further provided with the input unit 105 and the output unit 106, for example. Examples of the input unit 105 include: a pointing device such as a touch panel, a track pad, and a mouse; a keyboard; an imaging unit such as a camera and a scanner; a card reader such as an IC card reader and a magnetic card reader; and a voice input unit such as a microphone. Examples of the output unit 106 include a display such as a LED display and a liquid crystal display; a voice output unit such as a speaker; and a printer. The input unit 105 and the output unit 106 are separately configured in the first embodiment. However, the input unit 105 and the output unit 105 may be integrally configured like a touch panel display.

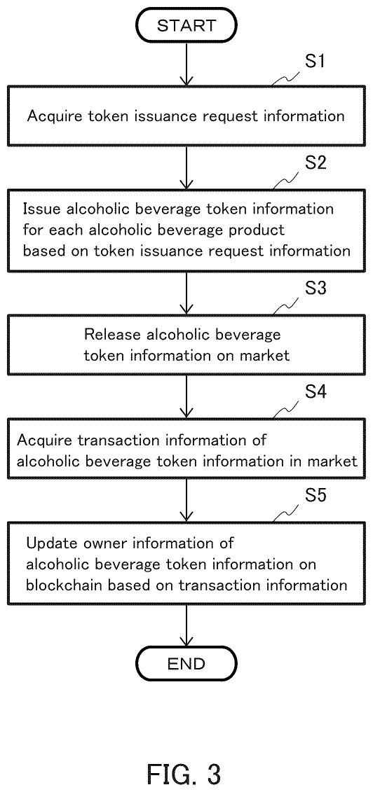

Next, an example of the alcoholic beverage token transaction support method according to the present disclosure will be described with reference to the flowchart of FIG. 3. The method according to the present disclosure is performed as follows using the apparatus 10 in FIG. 1 or 2, for example. Note that, the method according to the present disclosure is not limited to the use of the apparatus 10 of FIG. 1 or 2.

Firstly, the token issuance request acquisition part 11 acquires token issuance request information (S1, acquiring token issuance request). The token issuance request information is, for example, information for requesting issuance of alcoholic beverage token information to the apparatus 10 from a person who wants to issue alcoholic beverage token information described below (also referred to as an issuance requester, e.g., a provider of the alcoholic beverage product for the transaction (e.g., a manufacturer, a seller, and a distributor of the alcoholic beverage)) and includes product identification information of the alcoholic beverage product for the transaction. The product identification information is information that allows identifying the alcoholic beverage product for the transaction, for example. Specific examples of the product identification information include product appearance (product image), a product name, a product description, and various identification numbers such as a manufacturing number. The token issuance request acquisition unit 11 may acquire the token issuance request information, for example, from the terminal of an alcoholic beverage provider (issuance requester) 40 in FIG. 1, or from input by an administrator of the apparatus 10 who received information from the alcoholic beverage provider. The token issuance request acquisition part 11 may acquire the token issuance request information directly or indirectly from the terminal 40. In the latter case, the token issuance request information acquisition part 11 can acquire the token issuance request information from a server or a storage which acquires and accumulates the token request information outputted by the terminal 40, for example.

The token issuance request information may include information for a transaction, for example. The information for a transaction is, for example, information for a transaction of the alcoholic beverage token information with a transactor via the marketing part 13 described below. Examples of the information for a transaction include identification information of alcoholic beverage token information that is a transaction target, information on a transactor (e.g., the provider) (e.g., identification information of the transactor), information on a price of the alcoholic beverage token information, information on a probability of fluctuation of the price, a transaction acceptable term, information on the alcoholic beverage product specified by the product identification information associated with the alcoholic beverage token information (e.g., a trade name, an alcohol content, information on a production place (e.g., a production area and a manufacturer (brewery)), information on a manufacturing method (e.g., raw materials, a rice-polishing ratio, and a variety), information on taste (e.g., sweetness, sourness, and Nihonshu-do), and information on volume, production date, product appearance (e.g., a container image), and a product description. The transactor identification information is, for example, information for identifying the alcoholic beverage provider, and may include information such as a shop name, product information (type and price of the product), a delivery method, a name, a handle name, address, a phone number, mail address, ID, an identification number, and identification information of the terminal owned by the alcoholic beverage provider (e.g., a serial number, IMEI (International Mobile Equipment Identity), IP address, and MAC address).

Based on the token issuance request information, a token issuance part 12 then issues alcoholic beverage token information on a blockchain for the alcoholic beverage product specified by the product identification information (S2, issuing a token). The alcoholic beverage token information is, for example, an NFT (Non-Fungible Token) associated on a one-to-one basis with a product specified by the product identification information. The NFT has an original identifier that allows distinction between other NFTs, and thus can have its own value distinguished from other NFTs. Specifically, the token issuance part 12 can store the alcoholic beverage token information in each of nodes 31 on a blockchain network 30 connected to the apparatus 10 via a communication line network 20, to issue the alcoholic beverage token information on the blockchain. The token issuance part 12 may, for example, further record information on the alcoholic beverage product associated with the alcoholic beverage token information on the blockchain network 30. The token issuance part 12 may store, for example, the alcoholic beverage token information in the memory 102 or the storage 104. In this case, the token issuance part 12 may store product identification information of the alcoholic beverage product corresponding to the alcoholic beverage token information in association with the alcoholic beverage token information. Note that, while each of the nodes 31 on the block chain network 30 is described as a terminal different from the terminal of an alcoholic beverage provider 40 and the terminal of a transactor 50 in FIG. 1, the whole or a part of the terminal of an alcoholic beverage provider 40 and the terminal of a transactor 50 may function as the node 31 on the blockchain network 30.

The alcoholic beverage token information may include, for example, an additional program that realizes an additional function. The additional program is not particularly limited, and for example, a program for realizing a system such that a part of the distribution price is paid to the administrator of the apparatus 10 or the alcoholic beverage provider as fees when the alcoholic beverage token information is distributed from one to another. The alcoholic beverage token information may further include content information such as illustrations and other images, music, and the like, for example.

Thereafter, a marketing part 13 releases the alcoholic beverage token information on a market (S3, marketing a token). Specifically, the marketing part 13 can transmit the alcoholic beverage token information to a general blockchain marketplace via the communication line network to release the alcoholic beverage token information on the market, for example. The marketing part 13 may further transmit information for a transaction to the blockchain marketplace, for example. The information for a transaction is, for example, information necessary to carry out a transaction of an NFT on the blockchain market. The information for a transaction may be, for example, information included in the token issuance request information acquired in S1, or information stored in the memory 102 or the storage 104 of the apparatus 10. Specifically, for example, the whole or a piece of the information for a transaction may be stored in association with a user account registered by the alcoholic beverage provider to use the apparatus 10. The marketing part 13 itself may, for example, function as the blockchain marketplace, for example. In this case, the marketing part 13 of the apparatus 10 may be a market (store) server independent of other parts of the apparatus 10. In this case, the market (store) server is capable of, for example, communicating with a unit including other parts of the apparatus 10,. Note that, in the case where the marketing part 13 has the marketplace function, payment may be carried out by the apparatus 10 or may be separately carried out in the exterior of the apparatus 10. In the former case, the apparatus 10 may include a payment part, for example. In this case, the payment part can perform payment processing by acquiring transaction price information of the alcoholic beverage token information based on transaction information described below, transmitting the transaction price information to an external payment server, and acquiring a payment result achieved by the payment server. Note that the payment processing is not particularly limited, and for example, various methods in known payment units can be used therefor,.

The marketing part 13 may include, for example, a marketing function for reselling the alcoholic beverage token information. In this case, the marketing part 13 can, for example, acquire exhibition information of the alcoholic beverage token information from the owner of the alcoholic beverage token information and release the exhibition information on the market. Examples of the exhibition information include information specifying alcoholic beverage token information that the owner wants to resell, identification information of the owner (a name, a handle name, address, a phone number, mail address, ID, an identification number, and an identification number of the terminal owned by the alcoholic beverage provider or the administrator of the apparatus 10 (e.g., a serial number, IMEI (International Mobile Equipment Identity), IP address, and MAC address)), price information, and optional information described below.

Then, a transaction information acquisition part 14 acquires transaction information of the alcoholic beverage token information in the market (S4, acquiring transaction information). The transaction information is, for example, information relating to a transaction of the alcoholic beverage token information on the blockchain marketplace, and examples thereof include information on transactors (e.g., a seller, and a purchaser), a transaction date, a transaction place, alcoholic beverage token information for a transaction, and a transaction price. The transaction information may include, for example, optional information described in the following second embodiment. The transaction information acquisition part 14 can, for example, acquire the transaction information from a server that constructs the blockchain marketplace. When the marketing part 13 of the apparatus 10 has a function as the blockchain marketplace, the transaction information may be acquired from the marketing part 13. When the marketing part 13 has the marketing function for resale, the transaction information acquisition part 14 may, for example, acquire the transaction information of the alcoholic beverage token information in the market based on the exhibition information. The transaction information acquisition part 14 may, for example, store the acquired transaction information in the memory 102 or the storage 104.

A token management part 15 updates owner information of the alcoholic beverage token information on the blockchain, based on the transaction information (S5, managing a token). The token management part 15 can, for example, recognize a purchaser of the alcoholic beverage token information as an owner of the alcoholic beverage token information based on the transaction information, and register information on the purchaser on the blockchain network 30 as the owner information. When alcoholic beverage token information already owned by someone is exhibited by the marketing part 13 and purchased by another transactor, the token management part 15 registers the purchaser as a new owner of the traded alcoholic beverage token information on the blockchain network 30. The registration of the information on the blockchain 30 may be, for example, performed in the same way as in S2. In this way, the owner of the alcoholic beverage token information can be registered on the blockchain network 30 to clarify the owner of the product specified by the product identification information associated with the alcoholic beverage token information.

The apparatus of the present embodiment allows issuing alcoholic beverage token information associated on a one-to-one basis with a product specified by product identification information of the alcoholic beverage product, and recording a transaction of the alcoholic beverage token information with a blockchain network. Alcoholic beverage token information issued by the apparatus of the present embodiment, for example, is associated on a one-to-one basis with a product specified by the product identification information. Therefore, the apparatus of the present embodiment allows indirect transactions of alcoholic beverage products through transactions of the alcoholic beverage token information. The alcoholic beverage token information and the product identification information are in a one-to-one relationship. It is possible to record their transaction history and information on the alcoholic beverage product associated with the token alcoholic beverage token information, on a blockchain network. Accordingly, it is possible to secure authenticity and value of alcoholic beverage products for transactions.

Among alcoholic beverages, for example, transaction prices of wine especially rise with the lapse of time. This brings in a rise of its transaction prices in the secondary distribution and enhancement of its asset value. On the contrary, the asset value of sake, beer, plum liquor and shochu is unstable compared to that of wine. Further, raising transaction prices of these alcoholic beverage products is difficult because there is no marketplace for their secondary distribution. This leads to their low profitability. Hence, the apparatus of the present embodiment allows alcoholic beverage token information of these alcoholic beverage products to be issued, and sold by alcoholic beverage providers, and further to be for resale between other transactors via the alcoholic beverage token information. Therefore, the ultimate rise of their transaction prices can be expected. If the alcoholic beverage token information has the additional function such that a part of the distribution price is paid to the administrator of the apparatus 10 or the alcoholic beverage provider as fees when the alcoholic beverage token information is distributed from one to another for example, the profitability can be further increased. Since the market price of sake is often low against its product value compared to that of wine, the apparatus of the present embodiment is particularly suitable for supporting transactions via the alcoholic beverage token information of sake products.

### Second Embodiment

The second embodiment is another example of the apparatus of the present disclosure.

The alcoholic beverage token transaction support apparatus of the present embodiment is the same as the apparatus 10 of the first embodiment of which the reference is applicable, except for including an optional information acquisition part and an instruction information output part in addition to the configuration of the apparatus 10 of the first embodiment. An alcoholic beverage token transaction support apparatus 10A of the present embodiment includes, for example, an optional information acquisition part and an instruction information output part. The optional information acquisition part acquires optional information on the alcoholic beverage product in association with the alcoholic beverage token information. The instruction information output part generates instruction information based on the optional information and output the instruction information.

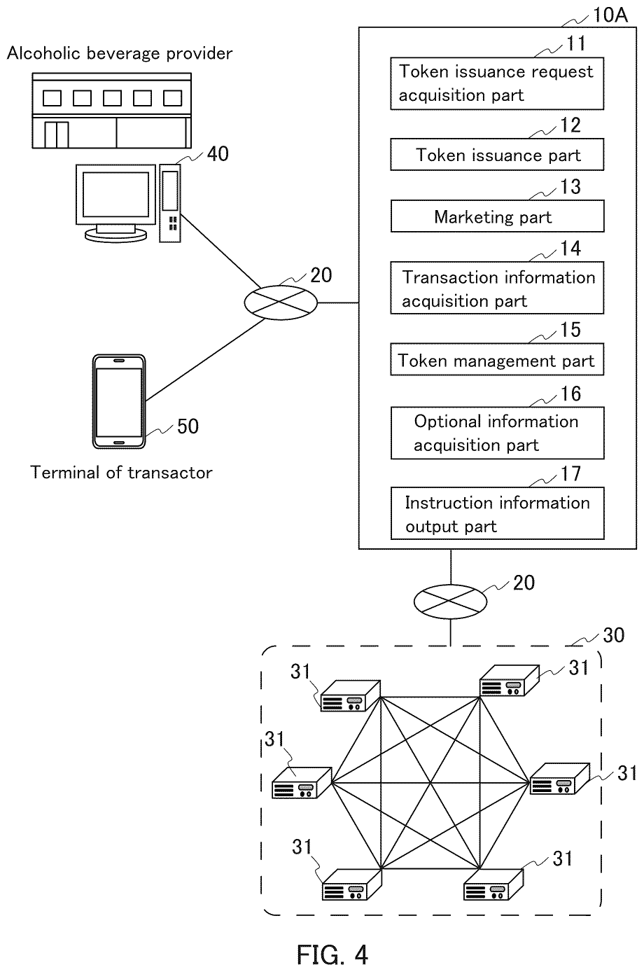

FIG. 4 is a block diagram showing an example configuration of the apparatus 10A of the present disclosure. As shown in FIG. 4, the apparatus 10A includes a product management instruction part 16 in addition to the configuration of the apparatus 10 of the first embodiment. A hardware configuration of the apparatus 10A is the same as that of the apparatus 10 in FIG. 2 except that the central processing unit 101 is provided with the configuration of the apparatus 10A in FIG. 4 instead of the configuration of the apparatus 10 in FIG. 1. Processing by the optional information acquisition part 16 and the instruction information output part 17 will be described below. Processing by the optional information acquisition part 16 and the instruction information output part 17 can be, for example, appropriately inserted in any position in the flowchart of FIG. 3 described in the first embodiment and is preferred to be inserted in the phase after S5.

The optional information acquisition part 16 acquires optional information on the alcoholic beverage product, for example (acquiring optional information). The optional information acquisition part 16 may, for example, acquire the optional information input by a user when processing a transaction in the marketplace, or may acquire the optional information separately inputted (purchased) by a user who has completed a transaction of the alcoholic beverage token information. In this way, the optional information acquisition part 16, for example, can acquire optional information on the alcoholic beverage product. The optional information acquisition part 16 may, for example, store the acquired optional information in the memory 102 or the storage 104 in association with the alcoholic beverage token information associated with the corresponding alcoholic beverage product. The token management part 15 may, for example, store the acquired optional information on the blockchain in association with the alcoholic beverage token information.

The optional information is, for example, information on options that can be selected by a purchaser in a transaction of the alcoholic beverage token information. A specific example of the optional information is information on how to handle (manage, store, and deliver) the alcoholic beverage product specified by the product identification information associated with the alcoholic beverage token information. The optional information includes, for example, information on storage of the alcoholic beverage product (storage temperature, a storage place, a storage period). The information on the storage state may be, for example, information specifically specifying temperature, humidity, lightness of the storage place, storage conditions (management conditions) of the storage container or the like, a storage period, or the like, or may be information specifying a category of the storage state (management state) such as freezing (quick-freezing), refrigerating, storage at a room temperature, and aging. In the latter case, the apparatus 10A is, for example, preferred to store the combination of a category of the storage state and the corresponding information on specific storage conditions in the storage part, for each alcoholic beverage product.

The optional information may include, for example, information on delivery of the alcoholic beverage product (a delivery agent, a delivery period, delivery conditions (temperature conditions such as refrigerating, freezing, a room temperature, or the like), a delivery destination, or the like). The information on delivery of the alcoholic beverage product may be, for example, simultaneously acquired with the information on handling of the alcoholic beverage product, or may be separately acquired. In the latter case, the optional information including the information on delivery is also referred to as delivery request information, for example. The owner of the alcoholic beverage token information may be, for example, able to request delivery of the alcoholic beverage product associated with the alcoholic beverage token information he/she owns, at any timing or only within a preset validity term of the alcoholic beverage token information.

Then, the instruction information output part 17 generates instruction information based on the optional information, and outputs the instruction information (instructing product management).

When the optional information includes the information on storage of the alcoholic beverage product, the instruction information output part 17 can, for example, generate product management instruction information as the instruction information, based on the optional information. Specifically, when the optional information includes specific information on the storage state of the alcoholic beverage product, the instruction information output part 17 can, for example, generate the information on the storage conditions as the instruction information. When the optional information is the information specifying a category of the storage state, the instruction output part 17 can refer to the storage part, refer to the storage conditions associated with the category of the storage state corresponding to the alcoholic beverage product purchased by the purchaser, generate and output the information on the storage conditions as the instruction information. An output destination of the instruction information may be a provider of the alcoholic beverage product, an administrator of the apparatus 10A, a delivery agent, or a custodian of the alcoholic beverage product, for example. The delivery agent and the custodian are, for example, preferred to be the ones designated by the administrator.

An administrator of the alcoholic beverage product, where the instruction information is outputted, can change the storage state of the alcoholic beverage product based on the instruction information. The storage state can be, for example, changed by the provider him/herself or someone who received an instruction from the administrator of the alcoholic beverage product (e.g., a delivery agent, a distribution agent, and a storage agent). Then, the provider can, for example, transmit information on the storage state of the alcoholic beverage product as management information to the apparatus 10A from the terminal of the provider (terminal 40). The instruction information output part 17 of the apparatus 10A can, for example, acquire the transmitted management information, and output the management information in association with the corresponding alcoholic beverage token information. The output may be, for example, performed directly to a terminal of the provider, a transactor, a purchaser, or the like, or may be performed so that the management information be browsable on the blockchain marketplace. Thus, the purchaser of the alcoholic beverage token information (owner of the alcoholic beverage product) can check the management information of the alcoholic beverage product via the apparatus 10A. Note that acquisition of the management information is not limited thereto, and the apparatus 10A may, for example, acquire storage information of the corresponding alcoholic beverage product as the management information by a camera or various sensors in a storage facility of the alcoholic beverage product.

When the optional information includes the information on delivery of the alcoholic beverage product, the instruction information output part 17 generates, for example, a delivery instruction based on the optional information and outputs the delivery instruction information. Specifically, the instruction information output part 17 generates, for example, the delivery instruction for arranging delivery of the alcoholic beverage product, based on the information on delivery of the alcoholic beverage product (a delivery agent, a delivery period, delivery conditions (temperature conditions such as refrigerating, freezing, and a room temperature), a delivery destination, or the like). Then, the instruction information output part 17 can output the delivery instruction to the terminal of the provider, the administrator, a delivery agent, a warehouse management agent, a distribution agent, or the like.

The administrator of the alcoholic beverage product who has received the instruction information, for example, arranges shipping of the alcoholic beverage product based on the delivery instruction. The shipping may be, for example, arranged by the administrator him/herself or someone who has received an instruction from the administrator (e.g., a delivery agent, a distribution agent, and a storage agent). The administrator can, for example, then transmit information on the delivery status of the alcoholic beverage product as the management information to the apparatus 10A from the terminal of the administrator (terminal 40). The instruction information output part 17 of the apparatus 10A can, for example, acquire the transmitted management information and output the management information in association with the alcoholic beverage token information. The output may be, for example, outputted directly to a terminal of the provider, a transactor, a purchaser, or the like, or may be outputted so that the management information is browsable on the blockchain marketplace. Thus, the purchaser of the alcoholic beverage token information (owner of the alcoholic beverage product) can check the delivery status of the alcoholic beverage product via the apparatus 10A.

The apparatus of the present embodiment can, for example, acquire optional information on storage or delivery of the product by the optional information acquisition part. Therefore, the apparatus of the present embodiment, for example, can change storage states and deliveries of the alcoholic beverage product based on the optional information selected by a purchaser of the alcoholic beverage token information. The value of an alcoholic beverage might largely fluctuate depending on the storage state of the alcoholic beverage. For example, the value of alcoholic beverages such as wine and whisky is enhanced by storing the alcoholic beverages in appropriate cool dark places for aging. On the contrary, regarding alcoholic beverages such as sake whose freshness is valued, it is important to maintain their freshness at the time of manufacturing by a flash-freezing treatment. The apparatus of the present embodiment allows a purchaser of the alcoholic beverage token information (NFT) to select long-term storage with quick-freezing treatment or aging in cool dark places to store the alcoholic beverage associated with the NFT, and ship the alcoholic beverage at any timing, so that the purchaser can maintain the asset value of the alcoholic beverage more stably and manage the value. Further, rating of the value of alcoholic beverage products based on their storage conditions varies largely depending on preferences or sense of value by consumers, even for the same alcoholic beverage products. Specifically for example, even for the alcoholic beverages of the same type manufactured by the same manufacturer, one consumer might highly rate the fresh alcoholic beverage right after manufactured, whereas another consumer highly rates the alcoholic beverage aged over a long period of time. However, storage and management conditions (e.g., whether flash-freezing the fresh alcoholic beverage right after manufactured or aging the alcoholic beverage) of alcoholic beverage products can be generally selected only by manufacturers or the like of the alcoholic beverage products, and transactors of the alcoholic beverage have no chance to be involved in the storage and management conditions of the alcoholic beverage products. Even in such a case, the apparatus of the present embodiment allows transactors of the alcoholic beverage token information to specify a category of the storage state as optional information. Accordingly, the present disclosure allows transactors, who purchased the alcoholic beverage token information, to have a choice of quick-freezing some alcoholic beverage products to secure the value for consumers who prefer fresh alcoholic beverages, and aging some alcoholic beverage products to secure the value for consumers who prefer aged alcoholic beverages, for example, so that the transactors can maintain the asset value of the alcoholic beverage more stably and manage the value.

### Third Embodiment

The third embodiment is an example of the use of the apparatus 10 (10A) of the first and the second embodiments.

The present embodiment describes an example case assuming that the alcoholic beverage product is sake, and a brewery that is the alcoholic beverage provider uses the apparatus 10 and generates an NFT of a sake product (sake NFT) to support a transaction of the alcoholic beverage product via the sake NFT. However, the present disclosure is by no means limited thereto.

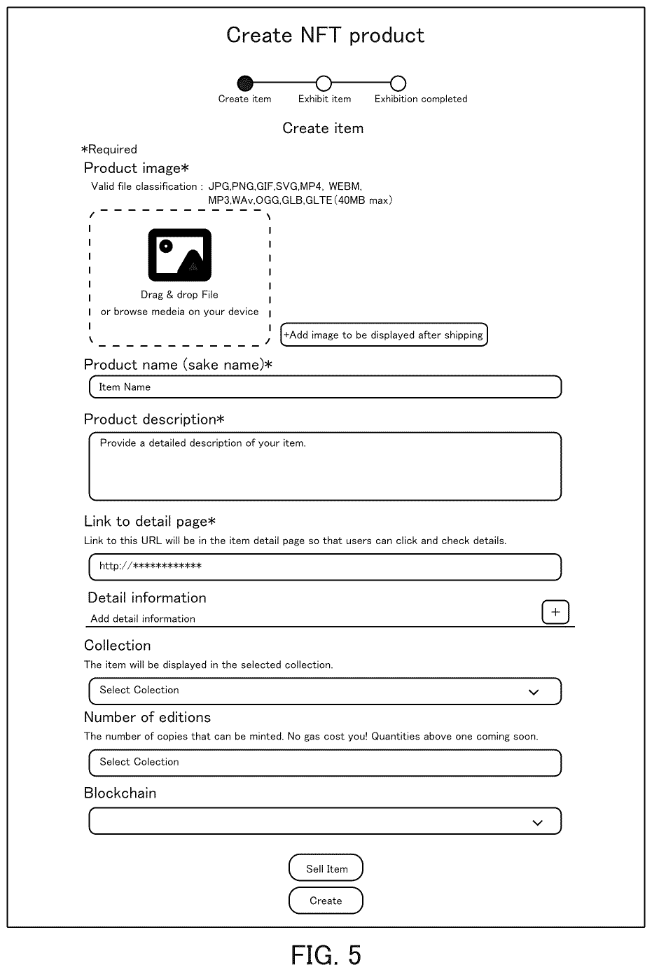

Firstly, an issuance requester of the sake NFT (e.g., an employee of a brewery that is the alcoholic beverage provider, and an administrator of the apparatus 10 who is commissioned by the alcoholic beverage provider), for example, accesses the apparatus 10 from a terminal of the requester 40, and inputs token issuance request information of the manufactured sake to perform an issuance request of the sake NFT. FIG. 5 shows an example display on the terminal 40 that has accessed the apparatus 10. Note that the example display of FIG. 5 is merely an example that by no means limits the present disclosure. The issuance requester of the sake NFT, for example, inputs necessary information to each item (a product image, a product name, a product description, a link to a detail page, detail information, collection, the number of editions, blockchain, or the like) in the display shown in FIG. 5 as the token issuance request information, to request issuance of the sake NFT.

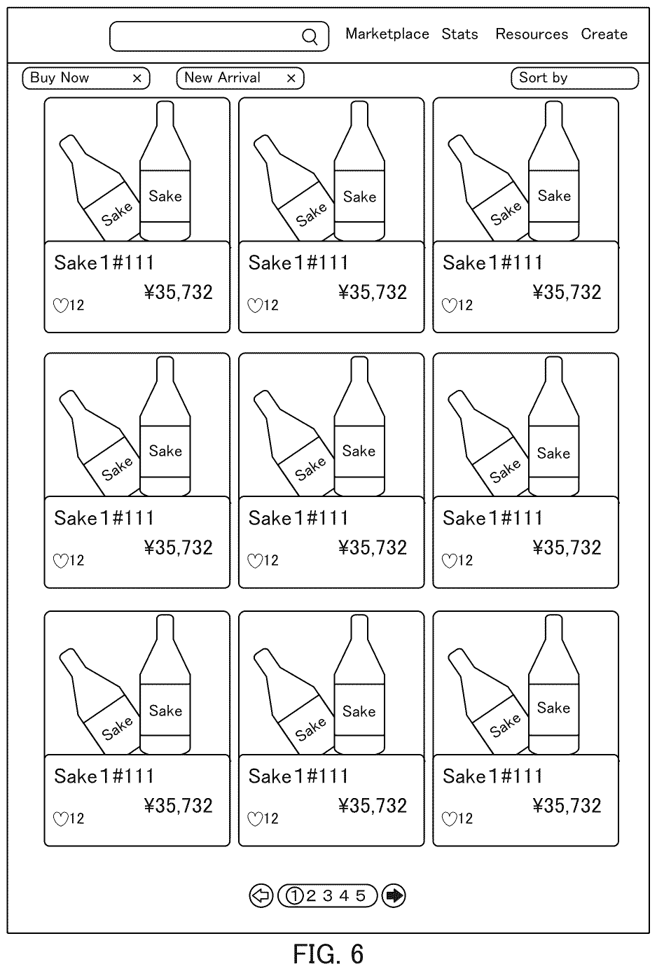

The apparatus 10 issues the sake NFT associated on a one-to-one basis with the product identification information on a blockchain. A marketing part 13 of the apparatus 10 then releases the registered sake NFT on a blockchain marketplace. FIG. 6 shows an example display of the NFT market released by the apparatus 10. However, the example display of FIG. 6 is merely an example that by no means limits the present disclosure. As shown in FIG. 6, the released sake NFT can be, for example, searched with a function of the marketplace, and can be listed with a search operation by a user. The search is not particularly limited and may be, for example, a keyword search, a price search, a tag search, or the like. The marketplace may also have, for example, a tag search function, a sort function, and a filter function, or the like. The marketplace may also have a function, for example, for counting and showing the number of views, likes, or the like of each sake NFT. Further, the marketplace may have a function for showing ranking of sake NFTs based on their transaction results (a turnover, a price, a price fluctuation range, views, likes, or the like), for example. In this case, tabulation for the ranking may be, for example, performed in each condition such as types of the blockchain, production areas, and transaction periods, for example.

A transactor who wants to purchase sake via the apparatus 10 accesses to the blockchain marketplace released by the apparatus 10 from a terminal of the transactor 50 to view the sake NFTs released as shown in FIG. 6. The transactor who wants to purchase the sake NFT he/she viewed, performs purchase processing of the sake NFT on the blockchain marketplace. When the released sake NFT is purchased on the blockchain marketplace, the apparatus 10 acquires transaction information of the sake NFT from the blockchain marketplace, and based on the transaction information, updates owner information of the alcoholic beverage NFT on the blockchain network from the alcoholic beverage provider to the transactor.

If the transactor selects, when purchasing the sake NFT, flash-freezing for 10 years as an optional information on the storage state of the sake for example, the apparatus 10 acquires the optional information. Thereafter, the apparatus 10 generates and outputs instruction information for instructing to store the sake product corresponding to the purchased sake NFT in a frozen state for 10 years by flash-freezing treatment. A destination of the output may be an administrator of the apparatus 10 or a manufacturer (brewery) of the sake product, as described above. Based on the instruction information, the administrator or the brewery then ships the sake product to a flash-freezing facility, makes the sake product to be subjected to flash-freezing treatment at the flash-freezing facility, and stores the treated sake product in a freezing warehouse. An owner or an administrator of the flash-freezing facility may be the same as or different from the administrator of the apparatus 10 or the brewery. However, the facility is preferred to be administered by the administrator of the apparatus 10. The apparatus 10 can acquire management information on the storage state of the sake product from the freezing warehouse, and output the acquired information to make the information be browsable on the blockchain marketplace. The management information may be, for example, information on an identification number of the sake NFT (token ID), a storage place, a shipping deadline, a warehousing date, delivery status, or the like.

If the transactor wants to conduct a transaction of his/her own sake NFT via the apparatus 10, the transactor accesses to the apparatus 10 from the terminal of the transactor 50, and inputs exhibition information for the blockchain marketplace. The marketing part 13 of the apparatus 10 releases, for example, the exhibition information on the blockchain marketplace. In this way, the transactor can conduct a transaction of his/her own sake NFT via the apparatus 10.

If the transactor needs to ship the sake product associated with his/her own sake NFT, the transactor accesses to the apparatus 10 from the terminal of the transactor 50 and inputs information on delivery of the sake product as the optional information. The apparatus 10 acquires the optional information on the delivery, generates a delivery instruction based on the optional information, and outputs the delivery instruction to a terminal of a warehouse administrator who administers the freezing warehouse. The warehouse administrator performs processing for shipping of the alcoholic beverage product corresponding to the sake NFT based on the delivery instruction. In this way, the transactor can deliver the sake product associated with his/her own sake NFT.

### Fourth Embodiment

The program of the present embodiment is a program causing a computer to execute each of the processes in the alcoholic beverage token transaction support method described above. Specifically, the program of the present embodiment is a program for causing a computer to execute acquiring a token issuance request, issuing token, marketing a token, acquiring transaction information, and managing a token.

Token issuance request information is acquired by the token issuance request acquisition process, the token issuance request information includes product identification information of an alcoholic beverage product that is a transaction target, alcoholic beverage token information is issued on a blockchain based on the token issuance request information, for the alcoholic beverage product specified by the product identification information by the token issuance process, the alcoholic beverage token information is released on a market by the marketing process, transaction information of the alcoholic beverage token information in the market is acquired by the transaction information acquisition process, and owner information of the alcoholic beverage token information on the blockchain is updated based on the transaction information by the token management process.

The program of the present embodiment may be referred to as a program causing a computer to function as acquiring a token issuance request, issuing the token, marketing the token, acquiring transaction information, and managing the token.

Descriptions of the apparatus and the method of the present disclosure can be applied to the program of the present embodiment. In each of the processes, for example, “process” and “processing” can be interchangeably used. The program of the present embodiment may be, for example, recorded in a computer-readable recording medium. The recording medium is, for example, a non-transitory computer-readable recording medium (storage medium). The recording medium is not particularly limited and examples thereof include a random access memory (RAM), a read only memory (ROM), a hard disk (HD), a flash memory (e.g., SSD (Solid State Drive), a USB flash memory, and a SD/SDHC card), an optical disc (e.g., CD-R/CD-RW, DVD-R/DVD-RW, and BD-R/BD-RE), a magneto-optical disk (MO), and a FLOPPY (registered trademark) disk (FD). The program (may be referred to as a programming product or a program product, for example) of the present embodiment may be, for example, distributed from an external computer. The “distribution” may be distribution via a communication line network or distribution via a wired-connected device. The program of the present embodiment may be executed by being installed in a device where the program is distributed, or may be executed without being installed.

While the present disclosure has been described above with reference to illustrative embodiments, the present disclosure is by no means limited thereto. Various changes and variations that may become apparent to those skilled in the art may be made in the configuration and specifics of the present disclosure.

This application claims priority from Japanese Patent Application No. 2023-027455 filed on Feb. 24, 2023. The entire subject matter of the Japanese Patent Application is incorporated herein by reference.

### SUPPLEMENTARY NOTE

The whole or part of the example embodiments disclosed above can be described as, but not limited to, the following supplementary notes.

### Supplementary Note 1

An alcoholic beverage token transaction support apparatus, including:
a token issuance request acquisition part;
a token issuance part;
a marketing part;
a transaction information acquisition part; and
a token management part, wherein
the token issuance request acquisition part acquires a token issuance request information,
the token issuance request information includes a product identification information of an alcoholic beverage product that is a transaction target,
the token issuance part issues an alcoholic beverage token information on a blockchain based on the token issuance request information, for the alcoholic beverage product specified by the product identification information,
the marketing part releases the alcoholic beverage token information on a market,
the transaction information acquisition part acquires transaction information of the alcoholic beverage token information in the market, and
the token management part updates an owner information of the alcoholic beverage token information on the blockchain based on the transaction information.

### Supplementary Note 2

The apparatus according to Supplementary Note 1, wherein
the marketing part acquires an exhibition information from an owner of the alcoholic beverage token information and releases the exhibition information on the market,
the transaction information acquisition part acquires the transaction information of the alcoholic beverage token information in the market based on the exhibition information, and
the token management part updates the owner information of the alcoholic beverage token information on the blockchain based on the transaction information.

### Supplementary Note 3

The apparatus according to Supplementary Note 1 or 2, including:
an optional information acquisition part, and
an instruction information output part, wherein
the optional information acquisition part acquires an optional information on the alcoholic beverage product in association with the alcoholic beverage token information, and
the instruction information output part generates an instruction information based on the optional information and outputs the instruction information.

### Supplementary Note 4

The apparatus according to Supplementary Note 3, wherein
the optional information includes information on storage of the alcoholic beverage product, and
the instruction information output part generates product management instruction information based on the optional information as the instruction information and outputs the product management instruction information.

### Supplementary Note 5

The apparatus according to Supplementary Note 3 or 4, wherein
the optional information includes information on delivery of the alcoholic beverage product, and
the instruction information output part generates delivery instruction information based on the optional information as the instruction information and outputs the delivery instruction information.

### Supplementary Note 6

The apparatus according to any one of Supplementary Notes 3 to 5, wherein
the instruction information output part acquires a management information of the alcoholic beverage product, of which the instruction information is outputted, and outputs the management information in association with the corresponding alcoholic beverage token information.

### Supplementary Note 7

An alcoholic beverage token transaction support method, including:
acquiring a token issuance request;
issuing a token;
marketing the token;
acquiring a transaction information; and
managing the token, wherein
token issuance request information is acquired in the acquiring the token issuance request,
the token issuance request information includes product identification information of an alcoholic beverage product that is a transaction target,
an alcoholic beverage token information is issued on a blockchain based on the token issuance request information, for the alcoholic beverage product specified by the product identification information in the issuing the token,
the alcoholic beverage token information is released on a market in the marketing the token,
the transaction information of the alcoholic beverage token information in the market is acquired in the acquiring the transaction information, and
an owner information of the alcoholic beverage token information on the blockchain is updated based on the transaction information in the managing the token.

### Supplementary Note 8

The method according to Supplementary Note 7, wherein
an exhibition information is acquired from an owner of the alcoholic beverage token information and the exhibition information is released on the market in the marketing the token,
the transaction information of the alcoholic beverage token information in the market is acquired based on the exhibition information in the acquiring the transaction information, and
the owner information of the alcoholic beverage token information on the blockchain is updated based on the transaction information in the managing the token.

### Supplementary Note 9

The method according to Supplementary Note 7 or 8, including;
acquiring an optional information; and
outputting an instruction information, wherein the optional information on the alcoholic beverage product is acquired in association with the
alcoholic beverage token information in the acquiring the optional information, and
the instruction information is generated based on the optional information and outputted in the outputting the instruction information.

### Supplementary Note 10

The method according to Supplementary Note 9, wherein
the optional information includes information on storage of the alcoholic beverage product, and
a product management instruction information based on the optional information is generated as the instruction information and outputted in the outputting the instruction information.

### Supplementary Note 11

The method according to Supplementary Note 9 or 10, wherein
the optional information includes information on delivery of the alcoholic beverage product, and
a delivery instruction information based on the optional information is generated as the instruction information and outputted in the outputting the instruction information.

### Supplementary Note 12

The method according to any one of Supplementary Notes 9 to 11, wherein
a management information of the alcoholic beverage product, of which the instruction information is outputted, is acquired, and outputted in association with the corresponding alcoholic beverage token information in the outputting the instruction information.

### Supplementary Note 13

A program for causing a computer to execute following processes, including:
a token issuance request acquisition process;
a token issuance process;
a marketing process;
a transaction information acquisition process; and
a token management process, wherein
token issuance request information is acquired by the token issuance request acquisition process,
the token issuance request information includes product identification information of an alcoholic beverage product that is a transaction target,
an alcoholic beverage token information is issued on a blockchain based on the token issuance request information, for the alcoholic beverage product specified by the product identification information by the token issuance process,
the alcoholic beverage token information is released on a market by the marketing process,
a transaction information of the alcoholic beverage token information in the market is acquired by the transaction information acquisition process, and
an owner information of the alcoholic beverage token information on the blockchain is updated based on the transaction information by the token management process.

### Supplementary Note 14

The program according to Supplementary Note 13, wherein
an exhibition information is acquired from an owner of the alcoholic beverage token information and released on the market by the marketing process,
the transaction information of the alcoholic beverage token information in the market is acquired based on the exhibition information by the transaction information acquisition process, and
the owner information of the alcoholic beverage token information on the blockchain is updated based on the transaction information by the token management process.

### Supplementary Note 15

The program according to Supplementary Note 13 or 14, including:
an optional information acquisition process, and
an instruction information output process, wherein
an optional information on the alcoholic beverage product is acquired in association with the alcoholic beverage token information by the optional information acquisition process, and
an instruction information is generated based on the optional information and outputted by the instruction information output process.

### Supplementary Note 16

The program according to Supplementary Note 15, wherein
the optional information includes information on storage of the alcoholic beverage product, and
a product management instruction information based on the optional information is generated as the instruction information and outputted by the instruction information output process.

### Supplementary Note 17

The program according to Supplementary Note 15 or 16, wherein
the optional information includes information on delivery of the alcoholic beverage product, and
a delivery instruction information based on the optional information is generated as the instruction information and outputted by the instruction information output process.

### Supplementary Note 18

The program according to any one of Supplementary Notes 15 to 17, wherein
a management information of the alcoholic beverage product, of which the instruction information is outputted, is acquired, and outputted in association with the corresponding alcoholic beverage token information by the instruction information output process.

### Supplementary Note 19

A computer-readable recording medium recording a program for causing a computer to execute following processes, including:
a token issuance request acquisition process;
a token issuance process;
a marketing process;
a transaction information acquisition process, and
a token issuance request information is acquired by the token issuance request acquisition process,
the token issuance request information includes a product identification information of an alcoholic beverage product that is a transaction target,
an alcoholic beverage token information is issued on a blockchain based on the token issuance request information, for the alcoholic beverage product specified by the product identification information by the token issuance process,
the alcoholic beverage token information is released on a market by the marketing process,
an transaction information of the alcoholic beverage token information in the market is acquired by the transaction information acquisition process, and
an owner information of the alcoholic beverage token information on the blockchain is updated based on the transaction information by the token management process.

### Supplementary Note 20

The recording medium according to Supplementary Note 19, wherein
an exhibition information is acquired from an owner of the alcoholic beverage token information and released on the market by the marketing process,
the transaction information of the alcoholic beverage token information in the market is acquired based on the exhibition information by the transaction information acquisition process, and
the owner information of the alcoholic beverage token information on the blockchain is updated based on the transaction information by the token management process.

### Supplementary Note 21

The recording medium according to Supplementary Note 19 or 20, including:
an optional information acquisition process, and
an instruction information output process, wherein
an optional information on the alcoholic beverage product is acquired in association with the alcoholic beverage token information by the optional information acquisition process, and
an instruction information is generated based on the optional information and outputted by the instruction information output process.

### Supplementary Note 22

The recording medium according to Supplementary Note 21, wherein
the optional information includes information on storage of the alcoholic beverage product, and
a product management instruction information based on the optional information is generated as the instruction information and outputted by the instruction information output process.

### Supplementary Note 23

The recording medium according to Supplementary Note 21 or 22, wherein
the optional information includes information on delivery of the alcoholic beverage product, and
a delivery instruction information based on the optional information is generated as the instruction information and outputted by the instruction information output process.

### Supplementary Note 24

The recording medium according to any one of Supplementary Notes 21 to 23, wherein a management information of the alcoholic beverage product, of which the instruction information is outputted, is acquired and outputted in association with the corresponding alcoholic beverage token information by the instruction information output process.

### INDUSTRIAL APPLICABILITY

The present disclosure allows issuing alcoholic beverage token information associated on a one-to-one basis with a product specified by product identification of an alcoholic beverage product, and recording a transaction of the alcoholic beverage token information with a blockchain network. Therefore, the present disclosure can be suitable used for electronic commerce, and especially for transactions of alcoholic beverage products.

### REFERENCE SIGNS LIST

10: alcoholic beverage token transaction support apparatus
11: token issuance request acquisition part
12: token issuance part
13: marketing part
14: transaction information acquisition part
15: token management part
16: optional information acquisition part
17: instruction information acquisition part
101: central processing unit
102: memory
103: bus
104: storage
105: input unit
106: output unit
107: communication device

1-24. (canceled)

25. An apparatus for alcoholic beverage token transaction support, comprising: at least one processor, wherein
the processor is configured to:
acquire a token issuance request information,
the token issuance request information comprises a product identification information of an alcoholic beverage product that is a transaction target,
issue an alcoholic beverage token information on a blockchain based on the token issuance request information for the alcoholic beverage product that is specified by the product identification information,
release the alcoholic beverage token information on a market,
acquire a transaction information of the alcoholic beverage token information in the market, and
update an owner information of the alcoholic beverage token information on the blockchain based on the transaction information.

26. The apparatus according to claim 25, wherein
the processor is configured to:
acquire an exhibition information from an owner of the alcoholic beverage token information,
release the exhibition information on the market,
acquire the transaction information of the alcoholic beverage token information in the market based on the exhibition information, and
update the owner information of the alcoholic beverage token information on the blockchain based on the transaction information.

27. The apparatus according to claim 25, wherein
the processor is configured to:
acquire an optional information on the alcoholic beverage product that is in association with the alcoholic beverage token information, and
generate an instruction information based on the optional information and outputs the instruction information.

28. The apparatus according to claim 27, wherein
the optional information comprises information on storage of the alcoholic beverage product, and
the processor is configured to generate a product management instruction information based on the optional information as the instruction information and outputs the product management instruction information.

29. The apparatus according to claim 27, wherein
the optional information comprises information on delivery of the alcoholic beverage product, and
the processor is configured to generate a delivery instruction information based on the optional information as the instruction information and outputs the delivery instruction information.

30. The apparatus according to claim 27, wherein
the processor is configured to:
acquire a management information of the alcoholic beverage product, of which the instruction information is outputted, and
output the management information in association with the corresponding alcoholic beverage token information.

31. A computer-implemented method for alcoholic beverage token transaction support, comprising:
acquiring the token issuance request,
the token issuance request information comprises a product identification information of an alcoholic beverage product that is a transaction target,
issuing an alcoholic beverage token information on a blockchain based on the token issuance request information for the alcoholic beverage product that is specified by the product identification information,
releasing the alcoholic beverage token information on a market,
acquiring the transaction information of the alcoholic beverage token information in the market, and
updating an owner information of the alcoholic beverage token information on the blockchain based on the transaction information.

32. The method according to claim 31, wherein
acquiring an exhibition information from an owner of the alcoholic beverage token information,
releasing the exhibition information on the market,
acquiring the transaction information of the alcoholic beverage token information in the market based on the exhibition information, and
updating the owner information of the alcoholic beverage token information on the blockchain based on the transaction information.

33. The method according to claim 31, comprising:
acquiring an optional information on the alcoholic beverage product in association with the alcoholic beverage token information, and
generating the instruction information based on the optional information and outputted.

34. The method according to claim 33, wherein
the optional information comprises information on storage of the alcoholic beverage product, and
generating a product management instruction information based on the optional information as the instruction information and outputted.

35. The method according to claim 33, wherein
the optional information comprises information on delivery of the alcoholic beverage product, and
generating a delivery instruction information based on the optional information as the instruction information and outputted.

36. The method according to claim 33, wherein
acquiring a management information of the alcoholic beverage product as the instruction information that is outputted, and
outputting the management information in association with the corresponding alcoholic beverage token information.

37. A non-transitory computer-readable recording medium recorded with a program, comprising:
the program causes a computer to execute a method for alcoholic beverage token transaction support, wherein,
the method comprising:
acquiring a token issuance request information,
the token issuance request information comprises a product identification information of an alcoholic beverage product that is a transaction target,
issuing an alcoholic beverage token information on a blockchain based on the token issuance request information, for the alcoholic beverage product specified by the product identification information,
releasing the alcoholic beverage token information on a market,
acquiring a transaction information of the alcoholic beverage token information in the market, and
updating an owner information of the alcoholic beverage token information on the blockchain based on the transaction information.

38. The recording medium according to claim 37, wherein
acquiring an exhibition information from an owner of the alcoholic beverage token information,
releasing released on the market,
acquiring the transaction information of the alcoholic beverage token information in the market based on the exhibition information, and
updating the owner information of the alcoholic beverage token information on the blockchain based on the transaction information.

39. The recording medium according to claim 37, further comprising:
acquiring an optional information on the alcoholic beverage product in association with the alcoholic beverage token information, and
generating an instruction information based on the optional information and outputted.

40. The recording medium according to claim 39, wherein
the optional information comprises information on storage of the alcoholic beverage product, and
generating a product management instruction information based on the optional information as the instruction information and outputted.

41. The recording medium according to claim 39, wherein
the optional information comprises information on a delivery of the alcoholic beverage product, and
generating a delivery instruction information based on the optional information i as the instruction information and outputted.

42. The recording medium according to claim 39, wherein
acquiring a management information of the alcoholic beverage product as the instruction information that is outputted, and
outputting the management information in association with the corresponding alcoholic beverage token information by the instruction information output process.
